(19) United States
(12) Patent Application Publication
(10) Pub. No.: US 2023/0180709 A1
(43) Pub. Date: Jun. 15, 2023

(54) PET WASTE SCOOPER

(71) Applicant: Worldwise, Inc., Novato, CA (US)

(72) Inventor: Carrie Van Wert, Eden Prairie, MN (US)

(21) Appl. No.: 18/077,352

(22) Filed: Dec. 8, 2022

Related U.S. Application Data
(60) Provisional application No. 63/288,332, filed on Dec. 10, 2021.

(51) Int. Cl. A01K 1/01

(52) U.S. Cl. CPC A01K 1/0114

(57) ABSTRACT

A pet waste scooper includes a handle portion, a scoop portion, and a support portion. The scoop portion has a receptacle for receiving pet waste and is at least partially defined by a bottom wall and a front wall. The support portion extends between the handle portion and the scoop portion and is configured to provide structural support to the pet waste scooper. The handle portion, the scoop portion, and the support portion are a unitary component that includes a pulp material.

### TECHNICAL FIELD

This invention relates to a pet waste scooper. More specifically, this invention relates to an environmentally friendly and pet friendly pet waste scooper.

### BACKGROUND

Litter box scoopers are used by pet owners in conjunction with a litter box to help provide a sanitary location for pets to relieve themselves, particularly cats. Such litter boxes are filled with a granular material, litter, which may absorb moisture and unpleasant odors.

Excrement is desirably routinely purged or scooped from the litter box. This is typically an unsanitary and unpleasant process to remove the excrement from the litter box reusing a scoop over an over without it being properly cleaned. Such conventional scoopers are typically plastic, structurally durable, and may function for a very long time. As such, they may become a breeding ground for bacteria if not cleaned properly with mild detergent. This may lead to contamination of the litter which, in sum, may also lead to health and behavioral problems for a cat. Some cleaning products are toxic to cats.

Misuse of the litter box is the leading reason cats are abused, surrendered or euthanized. The Animal Humane Society of the United States and many other leading veterinary medical authorities recommend that the litter box and scoop be thoroughly cleaned each time the litter is replaced—which for clumping litter may be 3-4 weeks and for non-clumping litter weekly. The ASPCA (American Society for the Prevention of Cruelty to Animals) recommends the litter box and scoop be properly cleaned weekly. This chore is unpleasant, inconvenient and may not occur, leading to the risk of the aforementioned health and behavioral issues.

The surface of plastic litter scoopers can become contaminated with stuck on debris. Conventional litter scoopers may be difficult to properly clean due to small and multiple slots, and the scoop being curved and not straight. Over time the scoop may become embedded with bacteria. When a user cleans the litter box and reuses a dirty scoop to remove waste debris, the litter box may be contaminated with bacteria. Subsequently, when a cat digs, the bacteria are flung into the air where the cat can breathe it in. When a user cleans the litter box, the user is also at risk of inhaling the bacteria. To prevent plastic scoopers from becoming contaminated with unhealthy bacteria it is recommended that a plastic scooper be replaced at least once per year. Replacing plastic scoopers leads to millions of pounds of plastic ending up in landfills that will not degrade for hundreds of years.

Another problem that comes from dirty plastic scoopers is foul odors. Waste matter can become trapped in even the smallest of scratches. The plastic then absorbs the odor, and it becomes impossible to eliminate, thus creating a problem for the cat and household. Ammonia is toxic to both humans and cats alike. Cat's sense of smell is far greater than humans and a cat may reject a foul-smelling litter box causing them to eliminate waste outside the box, resulting in the aforementioned health and behavioral problems.

### SUMMARY

An example of a pet waste scooper includes a handle portion, a scoop portion, and a support portion. The scoop portion has a receptacle for receiving pet waste and is at least partially defined by a bottom wall and a front wall. The support portion extends between the handle portion and the scoop portion and is configured to provide structural support to the pet waste scooper. The handle portion, the scoop portion, and the support portion are a unitary component that includes a pulp material.

Another example of a pet waste scooper includes a handle portion, a scoop portion, and a support portion. A receptacle of the scoop portion is at least partially defined by an apertured bottom wall, an angled front wall, a first side wall, a second side wall, a first rear wall, and a second rear wall. The first and second rear walls at least partially define an opening for a channel that extends between the scoop portion and the handle portion. The support portion extends between the handle portion and the first and second rear walls of the scoop portion. The handle portion, the scoop portion, and the support portion are a unitary component that includes pulp material.

An example of a method of manufacturing a pet waste scooper includes providing a slurry that includes a pulp material. The method also includes inserting the slurry into a mold such that the slurry takes the form of a pet waste scooper, and hardening the slurry such that the slurry maintains the form of the pet waste scooper. The method further includes removing the pet waste scooper from the mold after the slurry hardens.

### BRIEF DESCRIPTION OF THE DRAWINGS

FIG. 1 is a top-rear-perspective view of an example pet waste scooper;

FIG. 2 is a bottom-rear-perspective view of the pet waste scooper of FIG. 1;

FIG. 3 is a top-front-perspective view of the pet waste scooper of FIG. 1;

FIG. 4 is a bottom-front-perspective view of the pet waste scooper of FIG. 1;

FIG. 5 is a top view of the pet waste scooper of FIG. 1;

FIG. 6 is a bottom view of the pet waste scooper of FIG. 1;

FIG. 7 is a front view of the pet waste scooper of FIG. 1;

FIG. 8 is a rear view of the pet waste scooper of FIG. 1;

FIG. 9 is a right-side view of the pet waste scooper of FIG. 1;

FIG. 10 is a left-side view of the pet waste scooper of FIG. 1;

FIG. 11 is partial cross-sectional view of the pet waste scooper of FIG. 1 taken along the line A-A shown in FIG. 10, showing a first example of an angle of side walls for a channel of the pet waste scooper;

FIG. 12 is partial cross-sectional view of the pet waste scooper of FIG. 1 taken along the line A-A shown in FIG. 10, showing a second example of an angle of side walls for a channel of the pet waste scooper;

FIG. 13 is a right-side schematic view of an example of a pet waste scooper;

FIG. 14 is top schematic view of the pet waste scooper of FIG. 13;

FIG. 15 is a schematic view of an example for a stack of the pet waste scoopers of FIGS. 13-14; and

FIG. 16 is an example of a method of manufacturing a pet waste scooper.

### DETAILED DESCRIPTION

The Detailed Description describes exemplary embodiments of the invention and is not intended to limit the scope of the claims in any way. Indeed, the invention is broader than and unlimited by the exemplary embodiments, and the terms used in the claims have their full ordinary meaning. Features and components of one exemplary embodiment may be incorporated into the other exemplary embodiments. Inventions within the scope of this application may include additional features, or may have less features, than those shown in, and described in connection with, the exemplary embodiments.

As described herein, the terms “substantially” and “about” are defined as at least close to (and includes) a given value or state (preferably within 10% of, more preferably within 1% of, and most preferably within 0.1% of a given value or state).

“Pulp material” when used herein may refer to the wet pulp material (e.g., a slurry that is pre-drying or pre-forming) or the dried pulp material that is hardened to create the finished product.

The pet waste scoopers described herein are made from sustainable materials, improve litter box maintenance, and provide an enhanced ease of use and cleanliness to the pet owner. The disposability of the pet waste scoopers also provides increased or reoccurring sales to pet stores. The pet waste scoopers described herein resolve deficiencies with respect to conventional pet litter scoopers and have resolved such deficiencies with a pulp based litter scooper that provides features and advantages not available in plastic scoopers.

Conventional litter box/pet waste scoopers are formed of plastic. The polymers of such scoopers, for example polyethylenes, are for all practical purposes, impervious both to air and moisture. The surface of such polymer scoopers can be damaged by the abrasion of the litter when breaking up urine clumps or scraping the sides of litter boxes to remove stuck on debris. Such damage to the surface of the scoopers and cause shedding of plastic particles containing toxic compounds such as Bisphenol-A (BPA).

Stuck on debris on the scooper from moistened litter can be a site for bacteria growth as well as excrement and litter particle retention. Moreover, some veterinarians recommend replacing plastic litter waste scoopers at least once per year. However, simply throwing out and replacing plastic litter waste scooper is not environmentally desirable.

Additionally, a scooper usually contains small slots to allow for the litter to sift and such structural complexity is difficult to clean and sanitize. For example, the clumped litter and excrement may get trapped in the holes and complex structure. Moreover, interior of holes, particularly when the complex structure is configured as a grating cannot be easily contacted with cleaning tools. Complete cleaning can be tedious or nearly impossible. Although such scoopers can typically be adequately cleaned in automatic dishwashers, most pet owners are not inclined to put their litter box scooper into their kitchen dishwashers or to try to clean them in their kitchen sinks. Such conventional plastic and stainless-steel scoopers have these and other deficiencies with respect to maintaining cleanliness of the system and providing ease of use to users.

Humane societies report that a major reason cats end up at their facilities is litter box issues. They reject the litter box. This is likely caused, at least in part, by a pet owner's dislike of touching a dirty plastic scoop, so the pet owner neglects the cleaning duties and odors associated with the litter box (e.g., odors associated with bacteria growth).

Cats are sensitive to smell, and a clean litter box is more pleasing to cats and thereby would help to attract a cat to eliminate properly into a clean litter box. The pet waste scoopers described herein address the above issues and deficiencies and includes a pet waste scooper made from molded pulp material.

A pet waste scooper formed from pulp material presents numerous advantages as compared to conventional scoopers. At least part of the advantages is attributable to a reduction or elimination of odors emanating from the scooper. Bacterial growth is minimized or effectively eliminated in such systems, preventing odors caused by such bacteria. Pulp material, particularly when formed from recycled cardboard, grasses, bagasse, bamboo, and other organic material are offer numerous advantages and beneficial features as opposed to plastic and other conventional materials.

Examples of the pet waste scoopers described herein include pulp material-based pet waste scooper having an apertured bottom wall allowing easy removal of pet waste by allowing sifting as the smooth upper surface of the bottom wall with rounded comers does not significantly inhibit the sliding litter granules when sifting. In some instances, ribs are positioned intermediate elongate sifting openings, the elongate openings in planar bottom wall portions. This further facilitates the movement of the litter on the bottom wall and the sifting action of allowing unclumped litter to fall through the elongate openings.

A feature and advantage of the pet waste scoopers described herein that include pulp-based components is that molding such materials has a low impact on the environment compared to molding polymers. The pulp material may be easily formed from recycled cardboard, for example, by mixing and adding water, the pulp material does have to been heated to become flowable, as polymers do, and the pulp material rigidifies by drying. The pulp molds do not require the precision manufacture of plastic injection molding molds, do not have to withstand the extreme pressures of plastic injection molding operations, and are therefore easier to use and much less expensive thereby providing for a more reasonably priced product for the consumer. Additionally, disposal of the used pulp-based components is environmentally friendly, the components readily degrade in days or weeks compared to decades or centuries for plastic components. Disposal of pulp-based components have very limited impact on the environment compared to disposal of or even the recycling of plastic components.

Another feature and advantage of the pet waste scoopers described here is the ability to separate excrement from litter without requiring direct exposure to unsanitary items utilizing pulp-based components.

Another feature and advantage of the pet waste scoopers described herein is the ability to easily dispose of any components, such as scoopers, that become soiled with unsanitary biological waste matter where the disposal has minimal impact on the environment.

Another feature and advantage of the pet waste scoopers described herein is the reduction of undesirable waste byproducts such as plastics in pet waste scoopers.

Another feature and advantage of the pet waste scoopers described herein are structural features that facilitate use of pulp material, specifically providing rigidity, strength, and rounded comers, and that simultaneously facilitate efficient sifting of used litter.

Another feature and advantage of the pet waste scoopers described herein is that retailers can stock a pulp-based pet litter waste scooper that will have components discarded by customers in an environmentally friendly manner and that will then require the customers to return to purchase additional environmentally friendly pulp-based components. Thus, a feature and advantage of the pet waste scoopers described herein is repeat sales of the product not associated with plastic based pet waste scoopers.

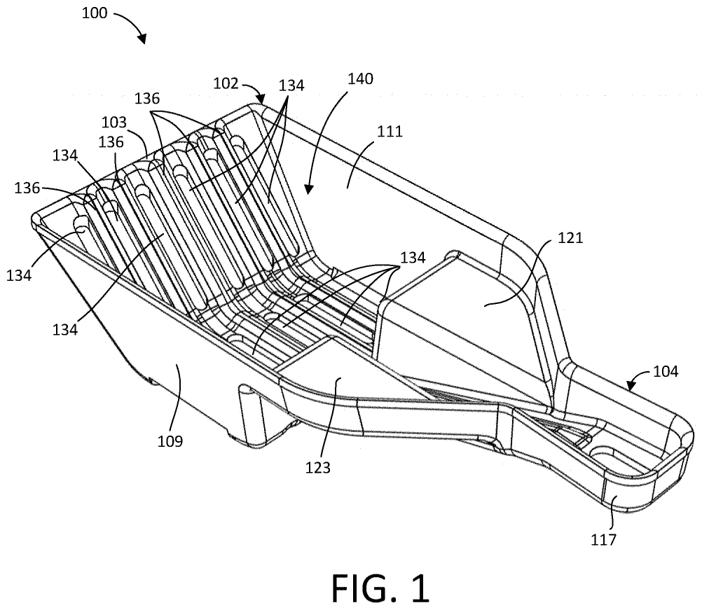

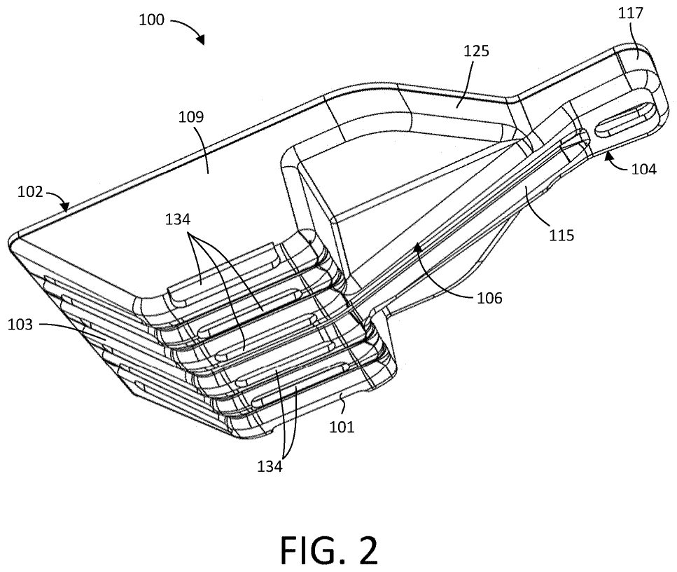

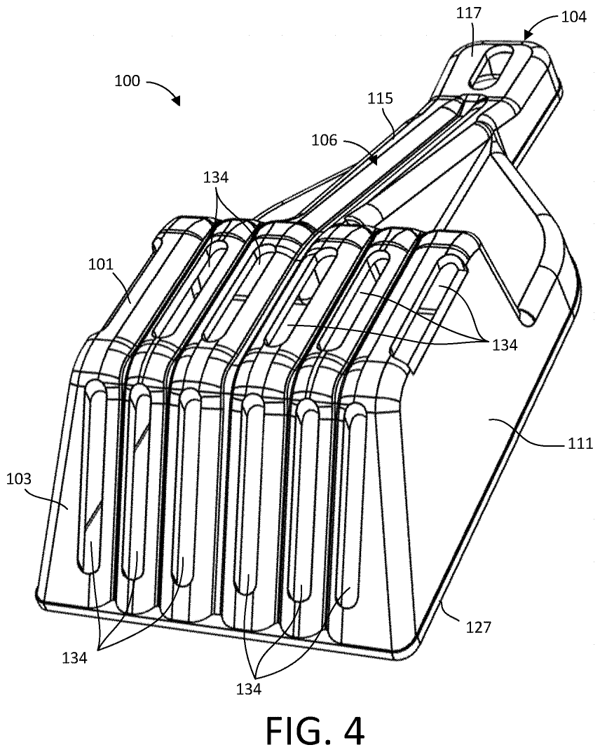

Referring to FIGS. 1-10, an example pet waste scooper 100 is illustrated that includes a scooper portion 102, a handle portion 104, and a support portion 106. The scooper portion 102 includes a receptacle 140 for receiving pet waste (e.g., cat waste or any other similar type of pet waste). The handle portion 104 includes a gripping component 117 that allows for a user to hold the pet waste scooper 100 and move the scooper portion 102 to engage and pick up pet waste. The support portion 106 extends between the scooper portion 102 and the handle portion 104 and provides support to the pet waste scooper 100 that prevents the pet waste scooper from collapsing or otherwise failing when being used to pick up pet waste.

The pet waste scooper 100 can be formed from a sustainable material, such as, for example, a pulp material. The pulp material can be, for example, recycled cardboard, paper pulp, bagasse, bamboo, wheat straw, plant-based pulp material. or any other suitable material that is biodegradable. The pet waste scooper 100 can be formed by applying a slurry that includes the pulp material around a form and then drying the slurry. The various portions 102, 104, 106 of the pet waste scooper 100 can be a unitary component, or one or more of the portions 102, 104, 106 can be formed separately from other portions and then connected together to create the pet waste scooper 100. The pet waste scooper 100 can be pressed or molded. Methods of molding pulp material into forms is known (see e.g., U.S. Pat. Nos. 3,046,187, 3,325,349, 3,243,096, 488,517, 5,656,135, and 1,551,257, all of which are incorporated herein in their entireties for all purposes). The pet waste scoopers 100 described herein can be used with various types of pet litter box systems, such as, for example, the pet litter box systems shown in U.S. Patent Publication 2020/0187450, which is incorporated herein in its entirety for all purposes.

In some examples, at least a portion of the pet waste scooper 100 can be made of components polymer or metallic materials. It is within the scope of this disclosure to have any combination of components formed of different materials. For example, a scooper 100 could include a polymer handle portion 104. Structural ribs 132, 136 (described in more detail below) can be made of a material other than the pulp material and then incorporated into the pet waste scooper 100 to provide structural support to the scooper 100. The ribs 132, 136 can alternatively be integral to one or more portions of the pet waste scooper 100. Some pulp materials can have an amount of plasticity such that they may be flexible or otherwise deformable. While the pet waste scooper 100 is described as being made from a pulp material, in alternative examples, the pet waste scooper can include the structure described in the present application, but can be made of any other suitable material for a pet waste scooper.

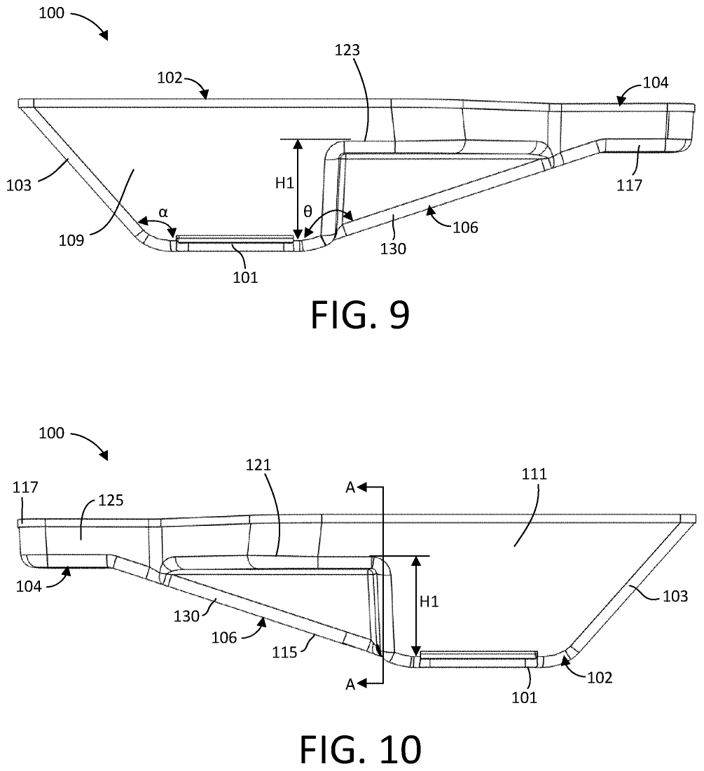

In the illustrated example, the scooper portion 102 has a bottom wall 101, a front wall 103, first and second rear walls 105, 107, a first side wall 109, and a second side wall 111 that is opposite the first side wall 109. In various examples, the front wall 103 is angled or sloped to facilitate scooping of pet waste. Each of the first and second rear walls 105, 107, the first and second side walls 109, 111, and the front wall 103 can extend upwardly from bottom wall 101. In the illustrated example, each of the first and second rear walls 105, 107 and the first and second side walls 109, 111 extends upwards from the bottom wall 101 at a 90-degree angle. However, in other examples, one or more of these walls can extend upwardly from the bottom wall 101 at any other suitable angle. In some instances, the first and second rear walls 105, 107 and the first and second side walls 109, 111 are joined to the bottom wall 101 at rounded corners. An angle α (FIG. 9) between the front wall 103 and bottom wall 101 can be between about 90 degrees and about 170 degrees, such as between about 105 degrees and about 145 degrees, such as about 130 degrees or about 132 degrees.

Referring to FIGS. 9 and 10, the support portion 106 can include a gusset member 130 that provides structural strength to the pet waste scooper 100. In the illustrated example, the gusset member 130 has a triangular shape, but the gusset member 130 can take any other suitable form. The gusset member 130 prevents the pulp material of the pet waste scooper 100 from twisting, collapsing, or tearing when the scoop is in use. The scooper is under particular stress when held by the handle portion 104 and force is exerted on the scooper portion 102, such as during scooping or sifting litter and pet waste. The gusset member 130 is configured to bear these stresses without breakage. In some instances, the handle portion 104 and the support portion 106 can be integral to each other such that a user directly grips the gusset member 130 when holding the handle portion 104.

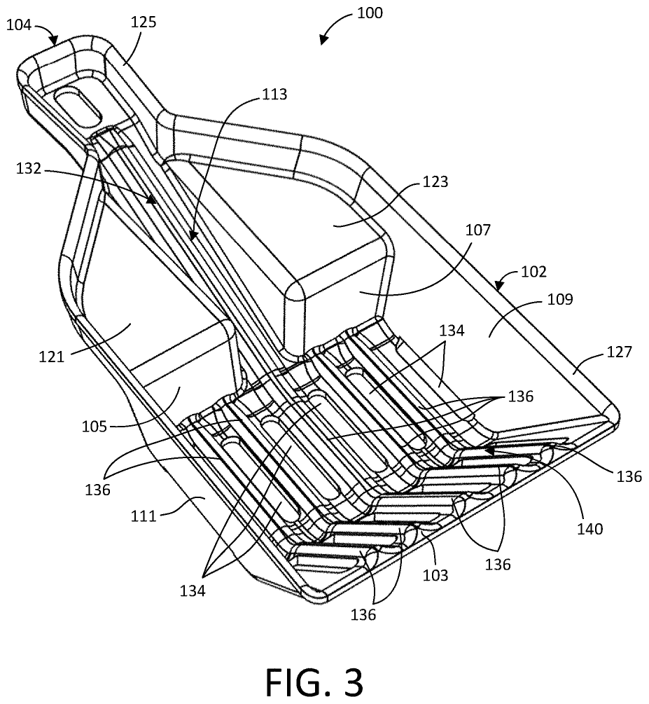

Referring to FIG. 3, an opening between the first and second rear walls 105, 107 defines an upwardly sloping channel 113, where the channel 113 includes a sloped bottom floor 115 that extends from bottom wall 101 to handle portion 104. The channel 113 can be sufficiently narrow such that most if not all pet waste will not fit therethrough as the scooper 100 is being used to scoop pet waste, which prevents the scooped pet waste from contacting the user. Referring to FIG. 9, an angle θ between the sloped floor 115 and bottom wall 101 can be between about 90 degrees and about 170 degrees. In embodiments, the angle θ between sloped floor 115 and bottom wall 101 is larger than the angle a between front wall 103 and bottom wall 101. In the illustrated example, raised shelf portions 121, 123 extend from a corresponding rear wall, 105, 107 to the handle portion 104. The channel 113 extends between the shelf portions 121, 123. The shelf portions 121, 123 can be generally flat and parallel to the bottom wall 101. Referring to FIGS. 9 and 10, the shelf portions 121, 123 can be vertically offset from bottom wall 101 by a height H1 of between about 15 mm and about 50 mm. In some instances, the sloped floor 115 may include one or more ribs 132 that add structural support and rigidity o the pet waste scooper 100. While the illustrated example, shows the sloped floor 115 having a single rib 132, it should be understood that the sloped floor 115 can have any suitable number of ribs. The ribs 132 can have a rounded surface, a flattened surface, or any other suitable type of shape. When multiple ribs 132 are included, the ribs 132 may be either uniform or staggered.

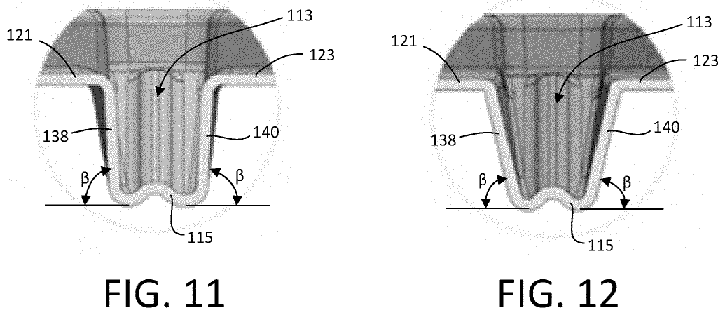

Referring to FIGS. 11 and 12, the channel 113 can includes side walls 138, 140 that are positioned at an angle β relative to a flat surface. Referring to FIG. 11, the angle β can be about 90 degrees. Referring to FIG. 12, the angle β can be about 70 degrees. In various examples, the angle β can be between about 50 degrees and about 90 degrees. In instances in which the pet waste scooper is formed from molding a pulp material, it is advantageous to have the angle β be less than 90 degrees (e.g., such as between about 50 degrees and 80 degrees) because the pet waste scooper 100 is easier to remove from the mold after being formed.

In the illustrated example, the sloped floor 115, the side walls 138, 140, and the raised shelf portions 121, 123 at least partially define the gusset member 130 of the support portion 106. However, in examples that do not include the sloped floor 115 and the channel 113 that extends between the scoop portion 102 and the handle portion 104, the gusset member 130 can include a piece of material without a channel that connects the scoop portion 102 and the handle portion 104. In any of examples described in the present application, the gusset member 130 can be integral to the scoop portion 102 and/or the handle portion 104, or the gusset member 130 can be a separate member from one or both of the scoop portion 102 and the handle portion 104 and be connected thereto (e.g., via an adhesive or other type of fastener).

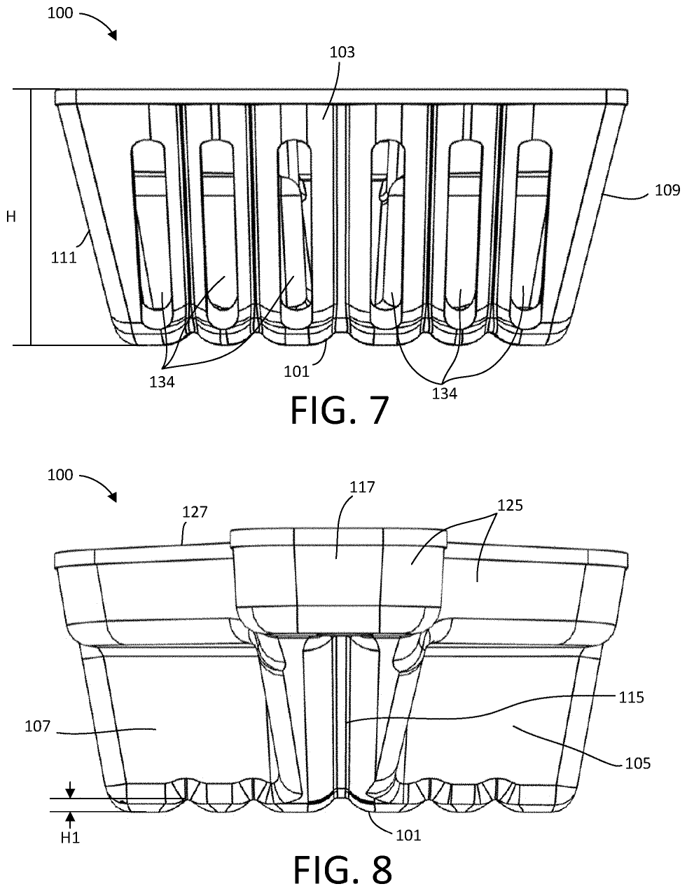

In various examples, a raised edge 125 surrounds shelf portions 121, 123 and handle portion 104. The raised edge 125 may be integral with first and second side walls 109, 111 such that pet waste scooper 100 has a common top circumferential lip 127. Referring to FIG. 7, the scooper 100 can have a height H of between about 25 mm and about 127 mm, such as between about 45 mm and about 65 mm, such as about 55 mm. Referring to FIG. 6, the scooper 100 can have a length L between about 152 mm and about 381 mm, such as between about 200 mm and about 300 mm, such as between about 225 mm and about 275 mm, such as about 254 mm or about 262 mm. The scooper 100 can have a width W between 75 mm and about 381 mm, such as between about 75 mm and about 150 mm, such as between about 100 mm and about 150 mm, such as about 120 mm or about 130 mm. The scooper 100 can have a thickness T of between about 2 mm and about 10 mm, such as between about 2 mm and about 6 mm, such as about 3 mm or about 5 mm. The scooper 100 can have a weight of between about 40 g and about 140 g, such as between about 40 g and about 70 g, such as between 40 g and 60 g, such as about 50 g.

Still referring to FIG. 6, the scoop portion 102 of the pet waste scooper 100 can have a length L1 of between about 80 mm and about 300 mm, such as between about 80 mm and about 150 mm, such as between about 100 mm and about 140 mm, such as about 110 mm or about 113 mm or about 120 mm. The handle portion 104 can have a length L2 of between about 40 mm and about 100 mm, such as between about 40 mm and about 80 mm, such as about 57 mm or about 60 mm. In some examples, the length L2 of the handle portion 104 is between about 5%-30% of the overall length L of the scooper 100, such as between about 10% and about 25% of the over length L, such as about 20% of the overall length L.

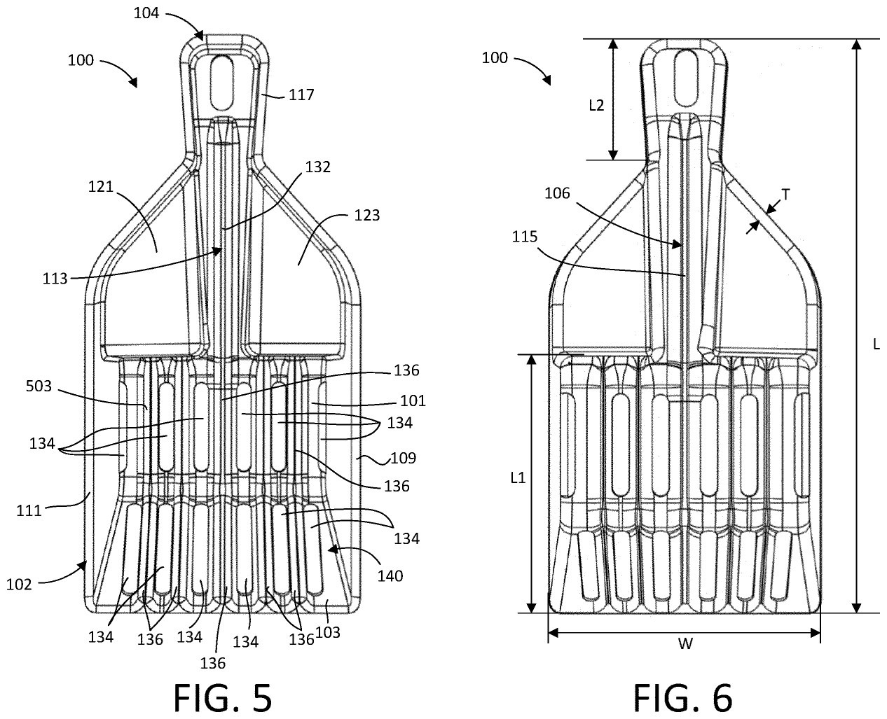

Referring to FIGS. 5 and 6, the scooper 100 can have openings 134 that permit sifting material to readily pass therethrough while limiting the passage of larger material (e.g., pet waste). The openings 134 can disposed on one or both of the bottom wall 101 and the front wall 103. In various examples, the openings 134 are flush with one or both of the bottom wall 101 and the front wall 103. While the openings 134 are illustrated as having an elongate shape, it should be understood that the openings 134 can take a wide variety of different shapes. For example, openings 134 may be oblong, circular, oval, rectangular, triangular, or any other suitable shape configured to act like a sieve. In various instances, the openings 134 may be generally uniform throughout the scooper 100. In other instances, the openings 134 may take on a variety of shapes or sizes throughout the scooper 100. For example, an opening 134 closer to a side wall 109, 111 of the scooper 100 may have a different size or shape than a more centrally situated opening 134. In various examples, the bottom wall 101 may include two or more openings, such as three or more openings, four or more openings, five or more openings, six or more openings, seven or more openings, eight or more openings, nine or more openings, ten or more openings, etc. The front wall 103 may include two or more openings, such as three or more openings, four or more openings, five or more openings, six or more openings, seven or more openings, eight or more openings, nine or more openings, ten or more openings, etc.

In various examples, an aspect ratio of a length (not shown) of an opening 134 to a width (not shown) of the opening 134 is between about 10 to 1 and about 1 to 1, such as between about 3 to 1 and about 8 to 1, such as about 3 to 1 or about 5 to 1. In some examples, openings 134 in the bottom wall 101 of the pet waste scooper 100 may have a width of between about 0.1 inches and about 0.75 inches, such as between about 0.1 inches and about 0.25 inches or between about 0.25 inches and about 0.5 inches. Openings 134 in the front wall 103 can have a width between about 0.1 inches and about 0.75 inches, such as between about 0.1 inches and about 0.25 inches or between about 0.25 inches and about 0.5 inches.

The pet waste scooper 100 may have ribs 136 extending from one or more walls of the scoop portion 102. In the illustrated example, the ribs 136 are positioned on both the bottom wall 101 and the front wall 103. However, the ribs 136 can be disposed on one of the bottom wall 101 and the front wall 103, or the ribs 136 can be disposed on any other portion of the pet waste scooper 100. The ribs 136 are configured to add structural support and rigidity to the pet waste scooper 100. The ribs 136 can have a rounded surface, a flattened surface, or any other suitable type of shape. The ribs 136 may be either uniform or staggered. In some instances, the ribs 136 can extend from the sloped front wall 103 and along the bottom wall 101 to rear walls 105, 107. The ribs 136 can be continuous or include multiple portions with breaks in between. In various examples, a plurality of ribs 136 may extend from the first side wall 109 to the second side wall 111. In various instances, the bottom wall 101 may include one or more ribs, such as two or more ribs, three or more ribs, four or more ribs, five or more ribs, six or more ribs, seven or more ribs, eight or more ribs, etc. In various instances, the front wall 103 may include one or more ribs, such as two or more ribs, three or more ribs, four or more ribs, five or more ribs, six or more ribs, seven or more ribs, eight or more ribs, etc.

During use, the front wall 103 of the scooper 100 may be inserted into a box of used litter. Openings 134 in the front wall 103 and/or bottom wall 101 permit litter to readily pass through, while retaining pet waste in the receptacle 140 of the scooper portion 102. The rearward walls 105, 107 assist in retaining waste within the scoop portion 102 while the scooper 100 is shaken back and forth to facilitate sifting of material. Various structural features of the pet waste scooper, such as a the gusset member 130, the plurality of ribs 136, the channel 113, and/or the raised shelf portions 121, 123 are configured to add rigidity to the scooper 100 so that the scooper 100 does not bend or collapse when it is pushed through litter.

During use, the scooper 100 may be gripped such that top of the gripping component 117 of the handle portion 104 is within a user's palm, while the user's fingers wrap around to the bottom side of the gripping component 117. The pet waste scooper 100 can be configured such that a user's thumb can extend down the open channel 113, which adds further support to the pet waste scooper 100 and allows the user to increase the amount of force used when scooping without bending or breaking the scooper.

The pet waste scooper 100 can be configured such that a plurality of the pet waste scoopers 100 can be configured to nest within one another. That is, multiple of the pet waste scoopers 100 can be configured to be stacked together to form a stack of pet waste scoopers (e.g., similar to the stack 201 of pet waste scoopers 200 shown in FIG. 15). This creates efficiencies for shipping, packaging, and displaying within stores. It may also be beneficial to stack two or more pet waste scoopers 100 to provide more rigidity to the pet waste scooper 100 when a user is using the pet waste scooper 100 to pick up pet waste. That is, structures made of pulp material can become more rigid as they are stacked, which helps prevent the pet waste scooper 100 from collapsing or otherwise deforming when a user is using the scooper 100 to scoop pet waste.

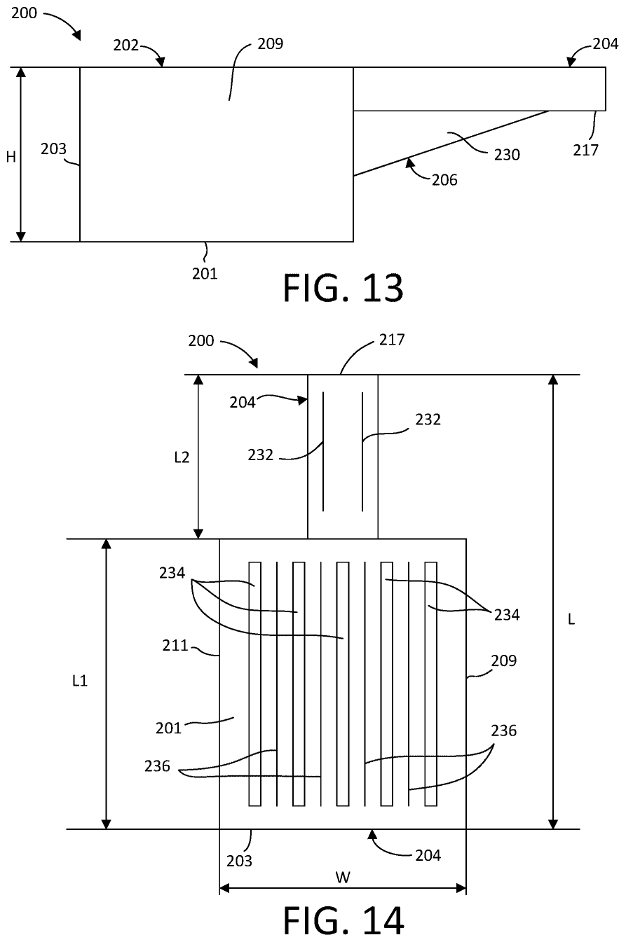

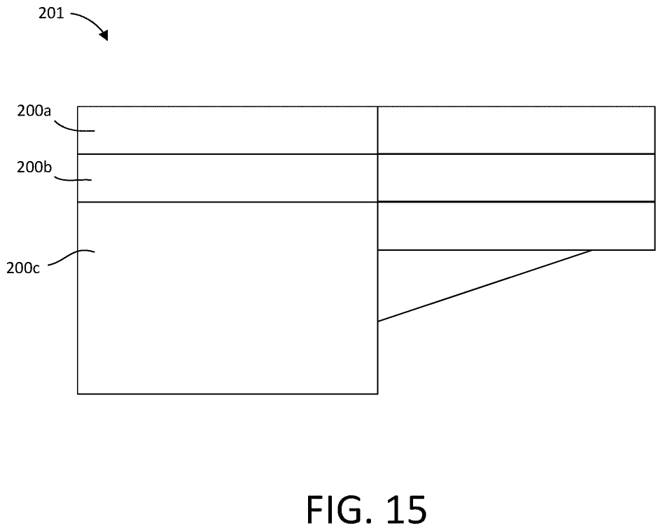

Referring to FIGS. 13 and 14, an example pet waste scooper 200 is illustrated that includes a scooper portion 202, a handle portion 204, and a support portion 206. The scooper portion 202 includes a receptacle 240 for receiving pet waste (e.g., cat waste or any other similar type of pet waste). The handle portion 204 includes a gripping component 217 that allows for a user to hold the pet waste scooper 200 and move the scooper portion 202 to engage and pick up pet waste. The support portion 206 extends between the scooper portion 202 and the handle portion 204 and provides support to the pet waste scooper 200 that prevents the pet waste scooper from collapsing or otherwise failing when being used to pick up pet waste.

The pet waste scooper 200 can be formed from a sustainable material, such as, for example, a pulp material. The pulp material can be, for example, recycled cardboard, paper pulp, bagasse, bamboo, wheat straw, plant-based pulp material. or any other suitable material that is biodegradable. The pet waste scooper 200 can be formed by applying a slurry that includes the pulp material around a form and then drying the slurry. The various portions 202, 204, 206 of the pet waste scooper 200 can be a unitary component, or one or more of the portions 202, 204, 206 can be formed separately from other portions and then connected together to create the pet waste scooper 200. The pet waste scooper 200 can be pressed or molded. Methods of molding pulp material into forms is known (see e.g., U.S. Pat. Nos. 3,046,187, 3,325,349, 3,243,096, 488,517, 5,656,135, and 1,551,257, all of which are incorporated herein in their entireties for all purposes). The pet waste scoopers 200 described herein can be used with various types of pet litter box systems, such as, for example, the pet litter box systems shown in U.S. Patent Publication 2020/0187450, which is incorporated herein in its entirety for all purposes.

In some examples, at least a portion of the pet waste scooper 200 can be made of components polymer or metallic materials. It is within the scope of this disclosure to have any combination of components formed of different materials. For example, a scooper 200 could include a polymer handle portion 204. Structural ribs 232, 236 (described in more detail below) can be made of a material other than the pulp material and then incorporated into the pet waste scooper 200 to provide structural support to the scooper 200. The ribs 232, 236 can alternatively be integral to one or more portions of the pet waste scooper 200. Some pulp materials can have an amount of plasticity such that they may be flexible or otherwise deformable. While the pet waste scooper 200 is described as being made from a pulp material, in alternative examples, the pet waste scooper can include the structure described in the present application, but can be made of any other suitable material for a pet waste scooper.

In the illustrated example, the scooper portion 202 has a bottom wall 201, a front wall 203, a rear wall 205, a first side wall 209, and a second side wall 211 that is opposite the first side wall 209. In the illustrated example, the front wall 203 extends upwardly from the bottom wall 201 at an angle a that is about 90 degrees. In other examples, the front wall 203 can be angled or sloped to facilitate scooping of pet waste. The angle α can be between about 90 degrees and about 170 degrees, such as between about 105 degrees and about 145 degrees, such as about 130 degrees or about 132 degrees. In some instances, the rear wall 205 and the first and second side walls 209, 211 can be joined to the bottom wall 201 at rounded corners. The rear wall 205 may be a continuous wall that extends between the first and second side walls 209, 211, or the rear wall 205 may include one or more openings or breaks between the first and second side walls 209, 211 (e.g., similar to the rear walls 105, 107 of the pet waste scooper 100 with the channel 113 positioned therebetween).

Referring to FIG. 13, the support portion 206 can include a gusset member 230 that provides structural strength to the pet waste scooper 200. In the illustrated example, the gusset member 230 has a triangular shape, but the gusset member 230 can take any other suitable form. The gusset member 230 prevents the pulp material of the pet waste scooper 200 from twisting, collapsing, or tearing when the scoop is in use. The scooper 200 is under particular stress when held by the handle portion 204 and force is exerted on the scooper portion 202, such as during scooping or sifting litter and pet waste. The gusset member 230 is configured to bear these stresses without breakage. The gusset member 230 can be integral to the scoop portion 202 and/or the handle portion 204, or the gusset member 230 can be a separate member from one or both of the scoop portion 102 and the handle portion 104 and connected thereto (e.g., via an adhesive or other type of fastener). The gusset member 230 can take any suitable form, such as, for example, any form described in the present application. In some instances, the handle portion 204 and the support portion 206 can be integral to each other such that a user directly grips the gusset member 230 when holding the handle portion 204.

The pet waste scooper 200 can have a raised edge (not shown) that surrounds the handle portion 204, where the raised edge may be integral with first and second side walls 209, 211 such that pet waste scooper 200 has a common top circumferential lip. In some examples, the handle portion 204 can include one or more ribs 232 that add structural support and rigidity o the pet waste scooper 200. While the illustrated example, shows the handle portion 204 having two ribs 232, it should be understood that the handle portion 232 can have any suitable number of ribs. The ribs 232 can have a rounded surface, a flattened surface, or any other suitable type of shape. When multiple ribs 232 are included, the ribs 232 may be either uniform or staggered.

Referring to FIG. 13, the scooper 200 can have a height H of between about 25 mm and about 127 mm, such as between about 45 mm and about 65 mm, such as about 55 mm. Referring to FIG. 14, the scooper 200 can have a length L between about 152 mm and about 381 mm, such as between about 200 mm and about 300 mm, such as between about 225 mm and about 275 mm, such as about 254 mm or about 262 mm. The scooper 200 can have a width W between 75 mm and about 381 mm, such as between about 75 mm and about 150 mm, such as between about 100 mm and about 150 mm, such as about 120 mm or about 130 mm. The scooper 100 can have a thickness (not shown) of between about 2 mm and about 10 mm, such as between about 2 mm and about 6 mm, such as about 3 mm or about 5 mm. The scooper 100 can have a weight of between about 40 g and about 140 g, such as between about 40 g and about 70 g, such as between 40 g and 60 g, such as about 50 g.

Still referring to FIG. 14, the scoop portion 202 of the pet waste scooper 200 can have a length L1 of between about 80 mm and about 300 mm, such as between about 80 mm and about 150 mm, such as between about 100 mm and about 140 mm, such as about 110 mm or about 113 mm or about 120 mm. The handle portion 204 can have a length L2 of between about 40 mm and about 100 mm, such as between about 40 mm and about 80 mm, such as about 57 mm or about 60 mm.

Still referring to FIG. 14, the scooper 200 can have openings 234 that permit sifting material to readily pass therethrough while limiting the passage of larger material (e.g., pet waste). While the openings 234 are only shown as being disposed on the bottom wall 201, it should be understood that the openings 234 can disposed on one or both of the bottom wall 201 and the front wall 203. In various examples, the openings 234 are flush with one or both of the bottom wall 201 and the front wall 203. The openings 234 can take any suitable shape, such as, for example, any shape described in the present application for the openings 134 shown in FIGS. 1-10. In various examples, the bottom wall 201 may include two or more openings, such as three or more openings, four or more openings, five or more openings, six or more openings, seven or more openings, eight or more openings, nine or more openings, ten or more openings, etc. The front wall 203 may include two or more openings, such as three or more openings, four or more openings, five or more openings, six or more openings, seven or more openings, eight or more openings, nine or more openings, ten or more openings, etc.

In various examples, an aspect ratio of a length (not shown) of an opening 234 to a width (not shown) of the opening 234 is between about 10 to 1 and about 1 to 1, such as between about 3 to 1 and about 8 to 1, such as about 3 to 1 or about 5 to 1. In some examples, openings 234 in the bottom wall 201 of the pet waste scooper 200 may have a width of between about 0.1 inches and about 0.75 inches, such as between about 0.1 inches and about 0.25 inches or between about 0.25 inches and about 0.5 inches. Openings 234 in the front wall 203 can have a width between about 0.1 inches and about 0.75 inches, such as between about 0.1 inches and about 0.25 inches or between about 0.25 inches and about 0.5 inches.

The pet waste scooper 200 may have ribs 236 extending from one or more walls of the scoop portion 202. In the illustrated example, the ribs 236 are positioned on the bottom wall 201. However, the ribs 236 can be disposed on the front wall 203, or on any other portion of the pet waste scooper 200. The ribs 236 are configured to add structural support and rigidity to the pet waste scooper 200. The ribs 236 can have a rounded surface, a flattened surface, or any other suitable type of shape. The ribs 236 may be either uniform or staggered. In some instances, the ribs 236 can extend from the front wall 203 and along the bottom wall 201 to the rear wall 205. The ribs 236 can be continuous or include multiple portions with breaks in between. In various examples, a plurality of ribs 236 may extend from the first side wall 209 to the second side wall 211. In various instances, the bottom wall 201 may include one or more ribs, such as two or more ribs, three or more ribs, four or more ribs, five or more ribs, six or more ribs, seven or more ribs, eight or more ribs, etc. In various instances, the front wall 203 may include one or more ribs, such as two or more ribs, three or more ribs, four or more ribs, five or more ribs, six or more ribs, seven or more ribs, eight or more ribs, etc.

During use, the front wall 203 of the scooper 200 may be inserted into a box of used litter. Openings 234 permit litter to readily pass through, while retaining pet waste in the receptacle 240 of the scooper portion 202. The rear wall 205 assists in retaining waste within the scoop portion 202 while the scooper 200 is shaken back and forth to facilitate sifting of material. Various structural features of the pet waste scooper, such as a plurality of ribs 236 and the gusset member 230 are configured to add rigidity to the scooper 200 so that the scooper 200 does not bend or collapse when it is pushed through litter.

Referring to FIG. 15, two or more of the pet waste scoopers 200 can be stacked to create a stack 201 of pet waste scoopers. In the illustrated example, the stack 201 includes a first pet waste scooper 200a, a second pet waste scooper 200b, and a third pet waste scooper 200c. The pet waste scoopers 200a-200c can take any suitable form, such as, for example the form of the pet waste scooper 100 shown in FIGS. 1-10 or the form of the pet waste scooper 200 shown in FIGS. 13-14. The stacking of pet waste scoopers creates efficiencies for shipping, packaging, and displaying within stores. It may also be beneficial to stack two or more pet waste scoopers 200 to provide more rigidity to the pet waste scooper 200 when a user is using the pet waste scooper 200 to pick up pet waste. That is, structures made of pulp material can become more rigid as they are stacked, which helps prevent the pet waste scooper 200 from collapsing or otherwise deforming when a user is using the scooper 200 to scoop pet waste.

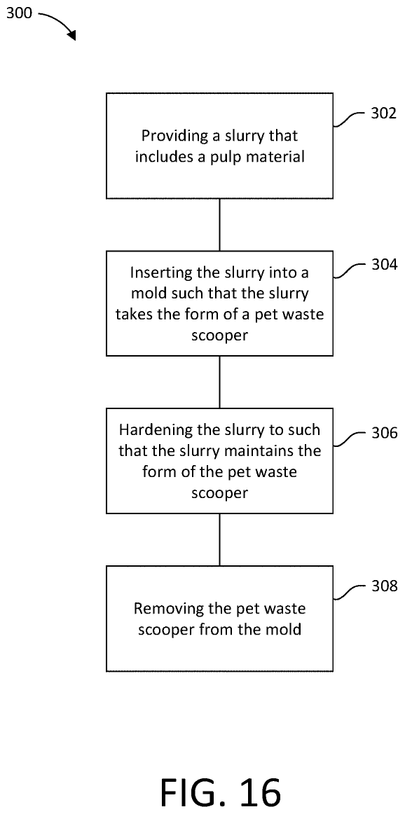

Referring to FIG. 16, an exemplary method 300 of manufacturing a pet waste scooper includes providing a slurry that includes a pulp material (as shown at box 302). The pulp material may take any suitable form, such as, for example, any form described in the present application. The method 300 further includes inserting the slurry into a mold such that the slurry takes the form of a pet waste scooper (as shown at box 304), and hardening the slurry such that slurry maintains the form of the pet waste scooper (as shown at box 306). The method 300 further includes removing the pet waste scooper from the mold (as shown at box 308). The pet waste scooper can take any suitable form, such as, for example, any form for a pet waste scooper described in the present application. In examples in which the pet waste scooper includes one or more openings (e.g., openings 134 for pet waste scooper 100 or openings 234 for pet waste scooper 200), the pet waste scooper may not include the openings when removed from the mold, but the openings may be cut into the pet waste scooper after being removed from the mold. In some instances, the pet waste scooper may include one or more features that allow for the pet waste scooper to be easily removed from the mold, such as, for example, the channel 113 of the pet waste scooper 100 having angles β that allow for the pet waste scooper to be easily pulled out of a mold.

While various inventive aspects, concepts and features of the inventions may be described and illustrated herein as embodied in combination with exemplary embodiments, these various aspects, concepts and features may be used in many alternative embodiments, either individually or in various combinations and sub-combinations thereof. Unless expressly excluded herein, all such combinations and sub-combinations are intended to be within the scope of the present inventions. Still further, while various alternative embodiments as to the various aspects, concepts and features of the inventions--such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein.

Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

1. A pet waste scooper, comprising:
a handle portion;
a scoop portion comprising a receptacle for receiving pet waste, the receptacle being at least partially defined by a bottom wall and a front wall, wherein at least one of the front wall and bottom wall comprises one or more ribs; and
a support portion that extends between the handle portion and the scoop portion, wherein the support portion is configured to provide structural support to the pet waste scooper;
wherein the handle portion, the scoop portion, and the support portion are a unitary component that comprises a pulp material.

2. The pet waste scooper according to claim 1, wherein at least one of the front wall and the bottom wall comprises one or more openings for permitting sifting material pass through the openings when a user is scooping pet waste.

3. The pet waste scooper according to claim 1, wherein the scoop portion comprises a first rear wall and a second rear wall that extend upwards from the bottom wall, wherein a sloped floor extends from the bottom wall to the handle portion, and wherein the first and second rear walls and the sloped floor at least partially defines a channel that extends from the bottom wall to the handle portion.

4. The pet waste scooper according to claim 3, wherein a first shelf extends between the channel and a first side wall, and wherein a second shelf extends between the channel and a second side wall.

5. The pet waste scooper according to claim 4, wherein the first shelf and the second shelf are lower than an upper most edge of the first and second side walls such that a lip extends around the first and second shelves and the handle portion.

6. The pet waste scooper according to claim 5, wherein the support portion comprises the first shelf, the second shelf, and the sloped floor.

7. The pet waste cooper according to claim 1, wherein the support member extends from a rear wall of the scooper portion to the handle portion.

8. The pet waste scooper according to claim 1, wherein an angle between the front wall and the bottom wall is between about 90 degrees and about 170 degrees.

9. The pet waste scooper according to claim 1, wherein the pulp material comprises at least one of cardboard pulp or fibrous pulp from bamboo, grasses, or bagasse.

10. The pet waste scooper according to claim 1, wherein the pulp material has a thickness of between about 2 mm and about 6 mm.

11. The pet waste scooper according to claim 1, wherein the pet waste scooper has a height of between about 25 mm and 127 mm.

12. The pet waste scooper according to claim 1, wherein the pet waste scooper has a width of between about 75 mm and about 381 mm.

13. The pet waste scooper according to claim 1, wherein the pet waste scooper has a length of between about 152 mm and about 381 mm.

14. The pet waste scooper according to claim 1, wherein the pet waste scooper has a weight of between about 4 grams and about 70 grams.

15. A pet waste scooper, comprising:
a handle portion;
a scoop portion comprising a receptacle for receiving pet waste, the receptacle being at least partially defined by an apertured bottom wall, an angled front wall, a first side wall, a second side wall, a first rear wall, and a second rear wall, wherein the first and second rear walls at least partially define an opening for a channel that extends between the scoop portion and the handle portion, and wherein the apertured bottom wall and the angled front wall each comprises one or more ribs; and
a support portion that extends between the handle portion and the first and second rear walls of the scoop portion, wherein the support portion is configured to provide structural support to the pet waste scooper;
wherein the handle portion, the scoop portion, and the support portion are a unitary component that comprises a pulp material.

16. The pet waste scooper according to claim 15, wherein a first shelf extends between the channel and the first side wall, wherein a second shelf extends between the channel and the second side wall, wherein a sloped floor extends from the bottom wall to the handle portion, wherein the first and second rear walls and the sloped floor at least partially define the channel, and wherein the support portion comprises the first shelf, the second shelf, and the sloped floor.

17. A method of manufacturing a pet waste scooper, the method comprising:
providing a slurry that includes a pulp material;
inserting the slurry into a mold such that the slurry takes the form of a pet waste scooper;
hardening the slurry such that the slurry maintains the form of the pet waste scooper; and
removing the pet waste scooper from the mold after the slurry hardens.

18. The method according to claim 17, wherein the pet waste scooper comprises:
a handle portion;
a scoop portion comprising a receptacle for receiving pet waste, the receptacle being at least partially defined by a bottom wall and a front wall, wherein at least one of the front wall and bottom wall comprises one or more ribs; and
a support portion that extends between the handle portion and the scoop portion, wherein the support portion is configured to provide structural support to the pet waste scooper.

19. The method according to claim 18, further comprising cutting openings into at least one of the bottom wall and the front wall of the scoop portion after the pet waste scooper is removed from the mold.

20. The method according to claim 17, wherein the pulp material comprises at least one of cardboard pulp or fibrous pulp from bamboo, grasses, or bagasse.
